(19) United States
(12) Patent Application Publication
(10) Pub. No.: US 2017/0053361 A1
(43) Pub. Date: Feb. 23, 2017

(54) POWER OUTPUT CALCULATING METHOD OF A SOLAR POWER PLANT

(71) Applicant: Sinogreenergy Consultant Co. Ltd., Taipei City (TW)

(72) Inventor: Kun-Hong CHEN, Taipei City (TW)

(21) Appl. No.: 14/831,407

(22) Filed: Aug. 20, 2015

(51) Int. Cl. G06Q 50/06

(52) U.S. Cl. CPC G06Q 50/06

(57) ABSTRACT

A power output calculating method of a solar power plant is disclosed herein and includes steps of: acquiring a first reference data of a first solar power plant at a historical time period; acquiring a second reference data of the first solar power plant; calculating a comparison value between the first reference data and the second reference data; acquiring a first historical power output of the first solar power plant corresponding to the first reference data when the comparison value is within an allowance range of an error tolerance value; and calculating a first future power output of the first solar power plant in accordance with the error tolerance value and the historical power output. By the calculated power output, the power manager can arrange power distribution effectively and the use of the power can be more effective.

### BACKGROUND OF THE INVENTION

1. Field of the Invention

The present invention relates to a power output calculating method of a solar power plant, and more particularly to a power output calculating method of a solar power plant to calculate the power output of the solar power plant in accordance with predictable data.

2. Description of Related Art

Since energy crisis, many countries are aggressively looking for a resource of alternative energy. Alternative energy can be wind power, solar power, geothermal energy, tidal energy, and so on rather than energy using coal, petroleum, gasoline, or nuclear. Solar power is inexhaustible in supply and the power generation device can be integrated with buildings. Moreover, the conversion efficiency of the solar power is increasing annually. Many countries actively promote the benefits to build solar power plants, so the solar power energy module is widely used.

However, the power efficiency of the solar power generation relies on sunshine, but the sunshine at four seasons is very different. Different climate will affect the power efficiency of the solar power generation. If weather is not good at some areas, the sunshine time is not long enough and the power generation efficiency of the solar power plant is not good. However, the consumption of electricity for livelihood or industrial use won't be decreased when weather is bad. If the power generation efficiency of the solar power plant is not good enough, the power plants at different areas have to provide extra power to compensate the power short from the solar power plant.

Accordingly, a need arises to design a power output calculating method to calculate a future power output of the power plant for the manager to predict the power generation to avoid power grid unbalance.

### SUMMARY OF THE INVENTION

Therefore, an objective of the present invention is to design a power output calculating method of a solar power plant. A future power output of the power plant can be calculated and a manager can arrange power distribution efficiently in accordance with the calculated power output by the calculating method.

According to the aforementioned objective, a power output calculating method of a solar power plant comprises steps of:
acquiring at least one first reference data of a first solar power plant from at least one historical time period;
acquiring a second reference data of the first solar power plant;
calculating at least one comparison value between the at least one first reference data and the second reference data;
acquiring at least one first historical power output of the first solar power plant corresponding to the at least one first reference data when the at least one comparison value is within an allowance range of at least one error tolerance value; and
calculating at least one first future power output of the first solar power plant in accordance with the error tolerance value and the at least one historical power output.

Another objective of the present invention is to provide a power output calculating method of a solar power plant. The power plant not able to acquire predictable data can calculate a first future power output by the calculating method in the present invention.

According to the aforementioned objective, a power output calculating method of a solar power plant comprises:
acquiring at least one first reference data of a first solar power plant from at least one historical time period;
acquiring a second reference data of a second solar power plant;
calculating at least one comparison value between the at least one first reference data and the second reference data;
acquiring at least one first historical power output of the first solar power plant corresponding to the at least one first reference data when the at least one comparison value is within an allowance range of at least one error tolerance value; and
calculating at least one first future power output of the second solar power plant in accordance with the error tolerance value and the at least one historical power output.

In accordance with the power output calculating method in the present invention, the power output of the power plant with predictable data can be calculated and the power output of the power plant without predictable data can also be calculated. According to the calculated future power output, the manager in the power plant can arrange power distribution effectively and the usage of the power can be more efficient to prevent an occurrence of the unbalance of the power grid.

### BRIEF DESCRIPTION OF THE DRAWINGS

FIG. 1A and FIG. 1B are flow charts of a power output calculating method of a solar power plant in a first embodiment of the present invention;

FIG. 2A-FIG. 2B are flow charts of the power output calculating method in a second embodiment of the present invention;

FIG. 3A is a timeline schematic diagram of a future power output of a testing solar power plant calculated in accordance with a historical power output of the testing solar power plant at the historical time period in the present invention;

FIG. 3B is a timeline schematic diagram of a future power output of the testing solar power plant calculated in accordance with the historical power output of other solar power plants at the historical time period in the present invention;

FIG. 4 is a comparison view of the testing solar power plant and the other solar power plant in the embodiment of the present invention; and

FIG. 5 is a view of the solar power plants to calculate the power output of the power plant without predictive reference data.

### DETAILED DESCRIPTION OF THE PREFERRED EMBODIMENT

These and other aspects of the embodiments herein will be better appreciated and understood when considered in conjunction with the following description and the accompanying drawings.

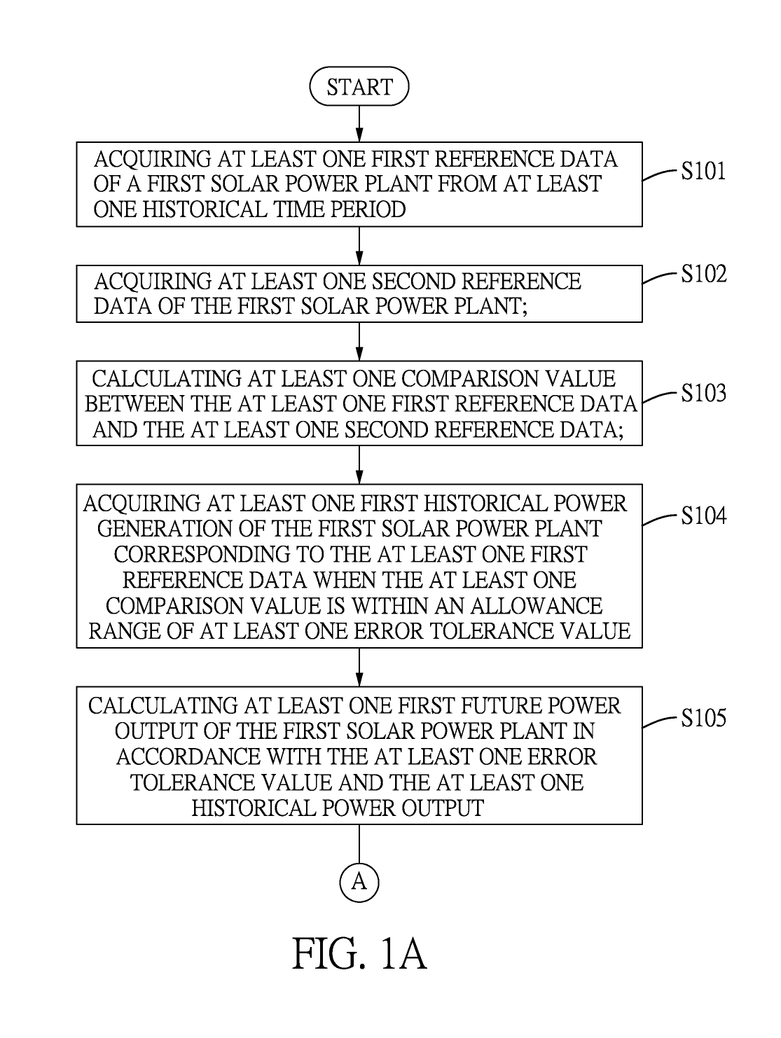

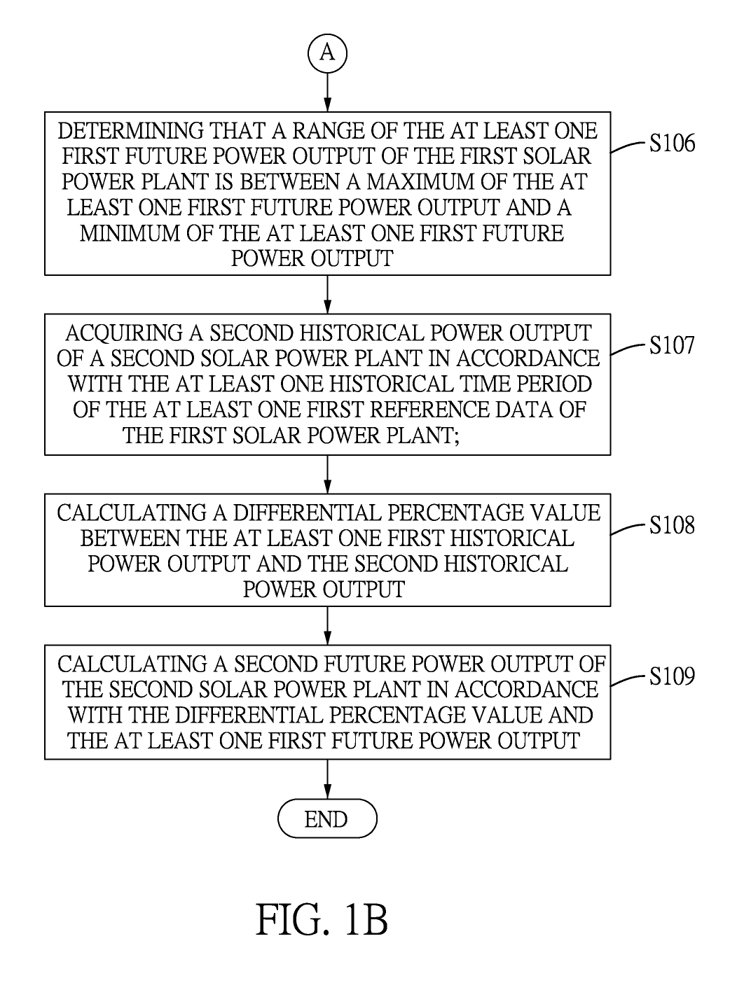

FIG. 1A and FIG. 1B are flow charts of a power output calculating method of a solar power plant. As shown in FIG. 1A and FIG. 1B, in step S101, at least one first reference data of a first solar power plant is acquired from at least one historical time period. The historical data and a historical power output of the first solar power plant are used as references in the calculating method of the present invention to calculate a future power output of the first solar power plant. The historical data of the first solar power plant can be weather data, external ambient factors of the power plant or any other factors (such as sunshine angle at the historical time period). In step S102, a second reference data of the first solar power plant is acquired. For example, the second reference data of the first solar power plant can be future weather information from weather forecast, external ambient factors of the solar power, future sunshine angle data and so on. The future weather information can be acquired from a weather forecast bureau or a weather forecast station or any weather forecast institutions. The external ambient factors of the power plant (such as whether close to rivers, whether close to ocean, whether close to roads and so on) won't have a huge change from time to time, but some minor changes in the external ambient factors of the power plant will affect the power output of the first solar power plant. Therefore, the external ambient factors of the solar power plant are required to be considered. In addition, any predictable parameters, which are available in public and will affect the power output of the power plant, can be the second reference data in the present invention.

In step S103, at least one comparison value between the at least one first reference data and the second reference data is calculated. And, in step S104, when the at least one comparison value is within an allowance range of at least one error tolerance value, at least one first historical power output of the first solar power plant corresponding to the at least one reference data is acquired. The first reference data used as reference information is determined by comparing a difference between the first reference data and the second reference data. If the difference between the first reference data and the second reference data is within an allowance range of the error tolerance value, the first reference data can be used as reference information and the first historical power output corresponding to the first reference data at the historical time period is acquired. In step S105, at least one first future power output of the first solar power plant is calculated in accordance with the error tolerance value and the at least one first historical power output. The first historical power output acquired from the aforementioned steps represents that the power generation condition (such as weather, external ambient factors or sunshine angles) of the solar power plant at this historical time period is similar to the power generation condition at the future time period, so the first historical power output can be used as reference to calculate the first future power output.

In addition, if more than one comparison value is within the allowance range of the multiple error tolerance values, more than one first historical power output can be acquired. Therefore, more than one first future power output can be calculated in accordance with the first historical power outputs. According to the first historical power outputs, in step S106, a range of the first future output power of the first solar power plant is determined to be between a maximum of the first future power output and a minimum of the first future power output. When more than one comparison value, which is between the first reference data and the second reference data, within the allowance ranges of the error tolerance values is found, more than one first historical power outputs can be acquired. Therefore, more than one first future output can be calculated in accordance with the first historical power outputs. Within the first future power outputs, the first future power output of the first solar power plant is determined between the maximum of the first future power output and the minimum of the future power output and a predictive power output range of the first solar power plant is given.

According to the aforementioned steps of the power output calculating method of the solar power plant, the first future power output is calculated. The first future power output is a future power output used as reference or an effective range is determined between more than one first future power output and used as a reference range of the first future power output. Accordingly, a reliable first future power output or a reliable first future power output range can be calculated. According to the first future power output or the first future output range, a manager in the solar power plant can arrange the power generation effectively, and the usage of the power generated by the solar power plant is more efficient.

Moreover, a future power output of the second solar power plant is further requested to be calculated, but the data, such as future weather information, external ambient factor or future sunshine angle, of the second solar power plant is not available. In step S107, at least one second historical power output of a second solar power plant is acquired in accordance with the at least one first reference data of the first solar power plant at the historical time period. In step S108, at least one differential percentage value between the first historical power output and the at least one differential percentage value is calculated. The purpose to calculate the differential percentage value is to understand the difference between the first historical power output of the first solar power plant and the second historical power output of the second solar power plant. In step S109, at least one second future power output is calculated in accordance with the at least one differential percentage value and the first future power output calculated from the first solar power plant. The second future power output is a future power output by referencing the first future power output of the first solar power plant. Although the data, such as the future weather information and so on, of the second solar power plant is not available, the second future power output of the second solar power plant can be calculated in accordance with the first future power output of the first solar power plant. According to the data, such as future weather information and so on, available in the first solar power plant, the first power output of the first solar power plant is calculated firstly. The second future power output of the second solar power plant is calculated according to the differential value between the first historical power output of the first solar power plant and the second historical power output of the second solar power plant at the same historical time period. In accordance with the aforementioned steps, not only the first future power output of the first solar power plant with predictable data can be calculated, but the second future power output of the second solar power plant without predictable data can also be calculated. In addition, the aforementioned error tolerance value can be different under different circumstances. If a more accurate prediction is required, the error tolerance value can be set to be smaller. If a rough prediction is required, the error tolerance value can be set to be larger.

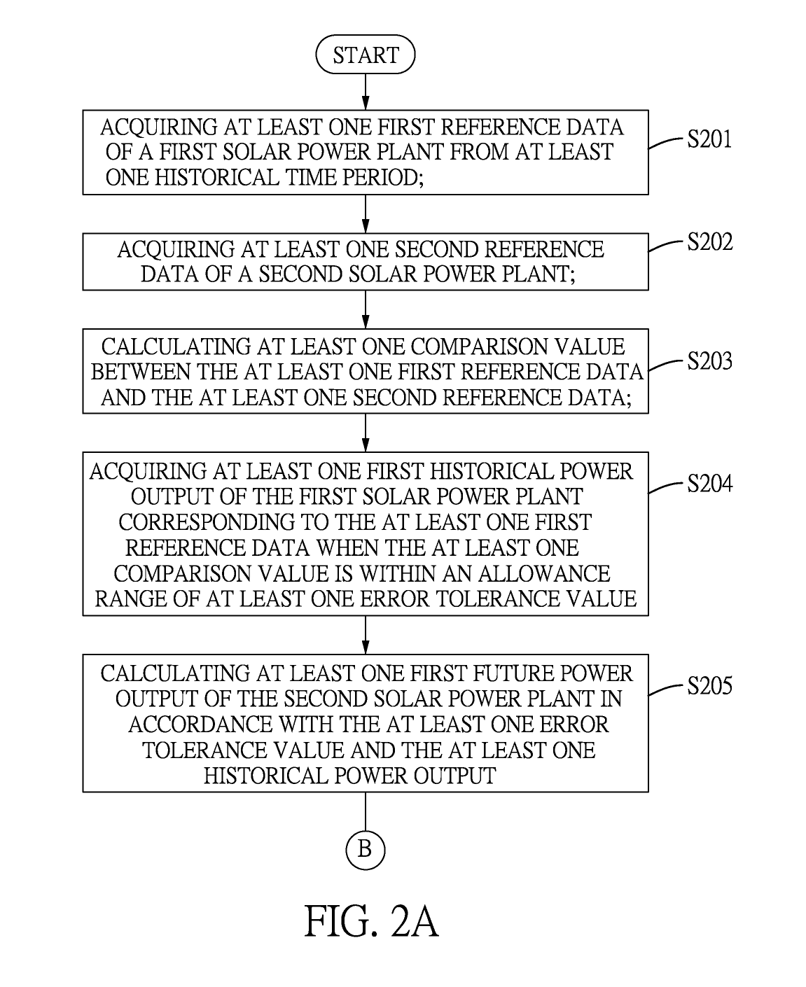

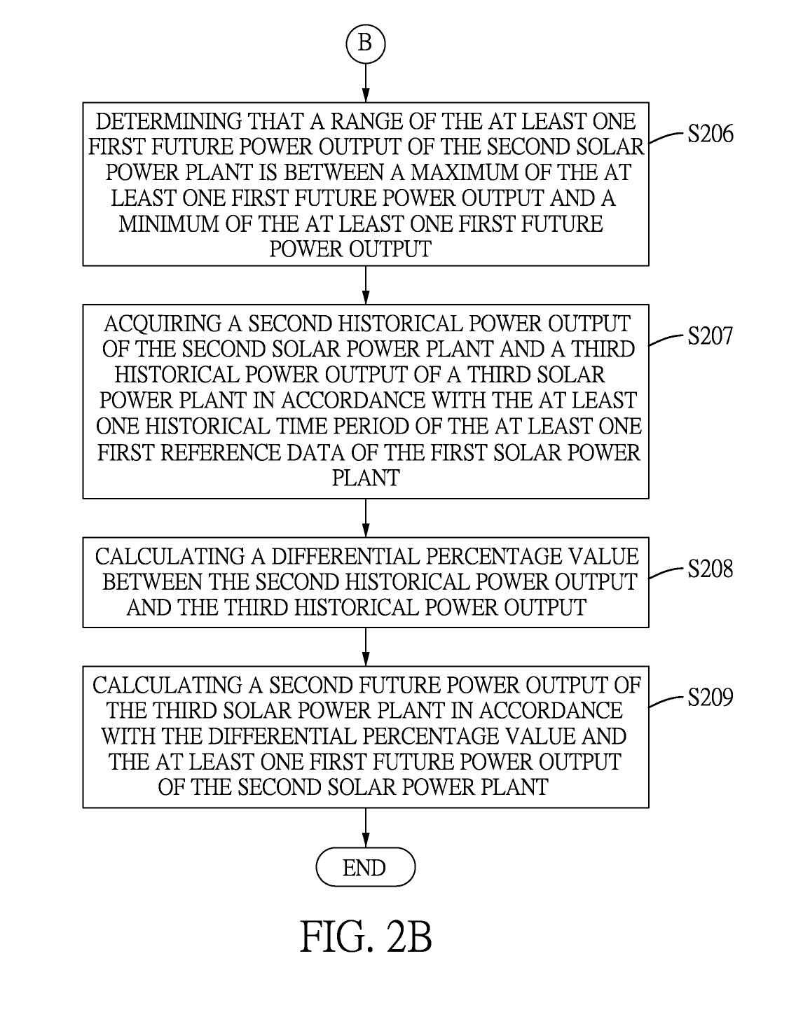

FIG. 2A and FIG. 2B are flow charts of the power output calculating method in a second embodiment of the present invention. As shown in FIG. 2A and FIG. 2B, in step S201, at least one first reference data of a first solar power plant is acquired in at least one historical time period. In the second embodiment, when a first future power output of a second solar power plant is to be calculated, historical data and historical power outputs of at least one first solar power plant are used as reference. According to the historical data and historical power output of the at least one first solar power plant, the first future power output of the second solar power plant is calculated. Similarly, the historical data of the first solar power plant can be past weather information, external ambient factors of the solar power plant or other factors (such as sunshine angle at historical time period). In step S202, a second reference data of a second solar power plant is acquired. The second reference data of the second solar power plant can be future weather information from a weather forecast report, external ambient factors of the power plant or future sunshine angles. The future weather information can be acquired from a weather forecast bureau, a weather forecast station or any weather forecast institutes. If the external ambient factors between the first solar power plant and the second solar power plant (whether close to river, whether close to ocean or whether close to road) are very different, the first solar power plant is not a proper power plant used as reference. Therefore, the external ambient factor of the power plant is a very significant reference data.

Thereafter, in step S203, at least one comparison value is calculated between the at least one first reference data and the second reference data. In step S204, when the at least one comparison value is within an allowance range of at least one error tolerance value, at least one historical power output of the at least one solar power plant corresponding to the at least one first reference data is acquired. According to the comparison between the first reference data and the second reference data, the first referent data is determined to be a useful reference data or not. When the difference between the first reference data and the second reference data is within the allowance range of the error tolerance value, the first reference data can be used as reference and the first historical power output corresponding to the first reference data of the first solar plant is acquired at the historical time period. In step S205, at least one first future power output of the second solar power plant is calculated in accordance with the error tolerance value and the at least one first historical power output. The first historical power output acquired from the aforementioned steps represents that the power generation condition (the at least one first reference data such as weather, ambient factors or sunshine angles) of the first solar power plant at this historical time period is similar to the power generation condition (the second reference data) of the second solar power plant at the future time period. In addition, when more than one comparison value is within the allowance range of the error tolerance value, more than one first historical power output of the first solar power plants is available to be used as reference and more than one first future power output can be calculated. According to more than one first future power output, in step S206, the first future power output of the second solar power plant is determined to be between the maximum of the first future power output and the minimum of the first future power output.

According to the aforementioned steps of the power output calculating method of the solar power plant, the first future power output of the second solar power plant can be calculated. The first future power output can be a future power output used as reference. Alternatively, more than one first power output is determined to include an effective range used as a reference range of a future output power. Therefore, a reliable first future power output or a reliable first future power output range can be calculated. According to the first future power output or the first future power output range, the manager of the solar power plant can arrange the power generation effectively, and the usage of the power generated by the solar power plant is more efficient.

In addition, when a power output of a third solar power plant is further required to be calculated and predictive data for the third solar power plant is not available, in step S207, a second historical power output of the second solar power plant and a third historical power output of a third solar power plant are acquired according to the historical time period of the first reference data of the at least one solar power plant. In step S208, a differential percentage value between the second historical power output and the third historical power output is calculated. In step S209, a second future power output is calculated in accordance with the differential percentage and the first future power output of the second solar power plant. The second future power output is a future power output calculated for the third solar power plant. Since the predictive data (future weather information and so on) of the third solar power plant is not available, the predictable first future power output of the second solar power plant is calculated firstly from the second solar power plant with predictable data (the second reference data). The difference between the second historical power output and the third historical power output is calculated according to the second historical power output of the second solar power plant and the third historical power output of the third solar power plant at the same historical time period. Finally, the second future power output of the third solar power plant is calculated in accordance with the difference and the calculated first future power output of the second solar power plant. According to the aforementioned steps, the first future power output of the second solar power plant with predictive data can be calculated and the second future power output of the third solar power plant without predictive data can also be calculated.

TABLE 1-1

| | Weather Information | | | |
|---|---|---|---|---|
| | Sunshine | | | |
| | (W/M2) | Temperature | Humidity | |
| Parameter | D1 | D2 | D3 | . . . |
| Future Time period | Da1(800) | 25 | 60% | |
| Historical Time period | Db1(850) | 27 | 70% | |
| Historical Time period | Dc1(750) | 23 | 50% | |
| . . . | . . . | . . . | . . . | |
| Historical Time period | Dn1(750) | 23 | 50% | |

TABLE 1-2

Ambient Factors of Power Plant

| | Road | | | |
|---|---|---|---|---|
| | (M) | Pool (M) | Ocean | |
| Parameter | D4 | D5 | (M) | . . . |
| Future Time Period | | | | |
| Historical Time Period | | | | |
| Historical Time Period | | | | |
| . . . | . . . | . . . | | |
| Historical Time Period | 5 M | 10 M | | |

TABLE 1-3

Others

| | Sunshine Angles | . . . |
|---|---|---|
| Parameter | θ1; θ2 | . . . |
| Future Time Period | θ1(60); θ2(30) | |
| Historical Time Period | θ1(65); θ2(35) | |
| Historical Time Period | θ1(55); θ2(25) | |
| . . . | . . . | . . . |
| Historical Time Period | θ1(55); θ2(25) | . . . |

TABLE 1-4

| Parameter | Power Output |
|---|---|
| Future Time Period | Pa |
| Historical Time Period | Pb |
| Historical Time Period | Pc |
| . . . | |
| Historical Time Period | Pn |

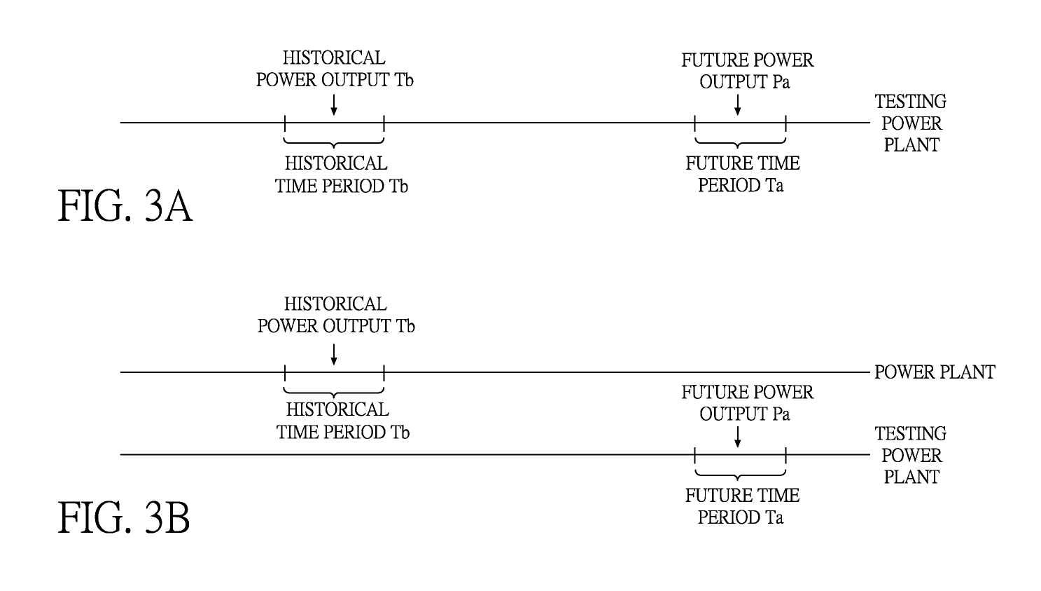

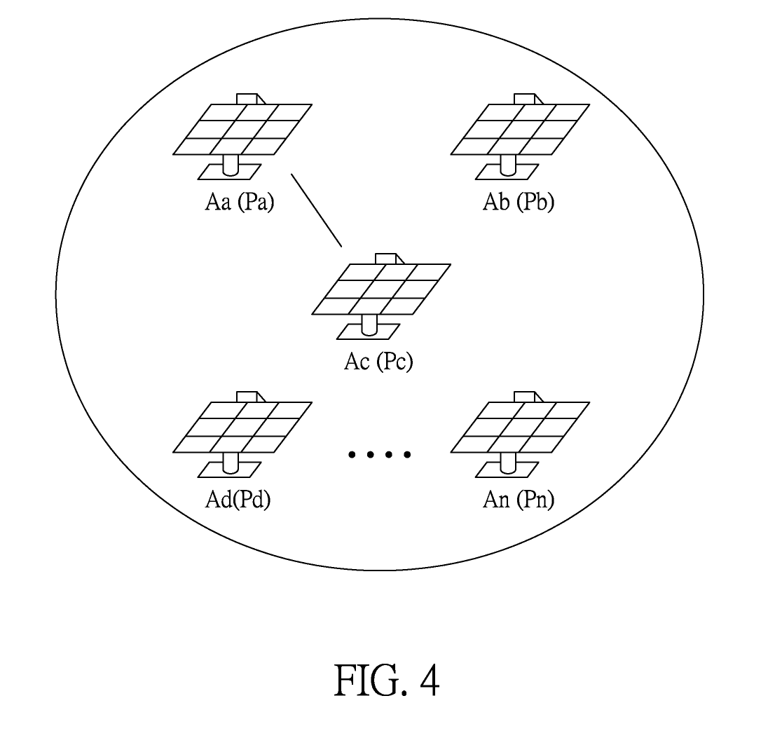

FIG. 3A is a timeline schematic diagram of a future power output of a testing solar power plant calculated in accordance with a historical power output of the testing solar power plant at the historical time period in the present invention. FIG. 3B is a timeline schematic diagram of a future power output of the testing solar power plant calculated in accordance with the historical power output of other solar power plants at the historical time period in the present invention. FIG. 4 is a comparison view of the testing solar power plant and the other solar power plants in the embodiment of the present invention. Tables 1-1-1-4 are reference data tables listing the reference data that will affect the power output efficiency of the solar power plant. As shown in Tables 1-1-1-4 with reference to FIG. 3A, FIG. 3B and FIG. 4, a horizontal axis in Tables 1-1-1-4 represents that those factors will affect the power output efficiency of the solar power plant. Those factors can be weather factors, geographic ambient factors of the solar power plant or other factors. The weather factors include sunshine, temperature, humidity, and so on. The geographic ambient factors of the power plant include a distance to a road, a distance to a pool, a distance to an ocean, and so on. Other factors can be sunshine angles. Different seasons or different time periods will have different sunshine angles and different sunshine angles will affect the power output efficiency. A vertical axis represents many comparison objects. For example, Pa represents a power output in one testing solar power plant at a future time period. Pb . . . Pn respectively represent a different power output in different power plants or Pb . . . Pn respectively represent a different power output in the testing solar power plant at different time periods. For example, the manager wants to calculate a power output Pa for next month (such as July) in the testing solar power plant. Pb can be the historical power output of the testing solar power plant in July last year and Pc can be the historical power output of the testing solar power plant in July the year before last year. Alternatively, Pb can be the historical power output of an adjacent power plant close to the testing solar power plant in July last year and Pc can be the historical power output of another adjacent power plant close to the testing solar power plant in July the year before last year and so on and so forth.

For example, when the manager chooses sunshine to be reference data to calculate power output of the power plant (Aa), the sunshine (Da1) of the testing power plant (Aa) acquired from the weather station is 800 and the sunshine (Db1) of the power plant (Aa) is 850. The comparison value between the predictive sunshine (Da1) and the historical sunshine (Db1) is (Da1−Db1)/Da1=(800−850)/800=−6.67%, and the error tolerance value is set to be −10% (k %=−10%). The comparison value is within the allowance range of the tolerance value (such as |−6.67%|≦|−10%|). Therefore, the sunshine at this historical time period can be used as reference, and the power output (Pb) of the power plant (Ab) at this historical time period is acquired. The predictive power output (Pa) of the power plant (Aa) is Pa=Pn(1+k %)=Pb(1−10%). The calculated power output is used as the predictive power output. When the manager finds more than one comparison value within the allowance range of the error tolerance values, the predictive power output of the power plant (Aa) is between a minimum of the calculated power output and a maximum of the calculated power output. In addition, in a different embodiment, the data (Db1) can be sunshine data in a different power plant and the predictive reference value of the power plant (Aa) is compared with the historical value of the power plant (Aa) itself. Alternatively, the predictive reference value of the power plant (Aa) is compared with the historical value of the different power plant (Ab), and it is not limited herein.

Moreover, in the embodiment of the present invention, more than one reference data can be compared. The comparison values of the weather information (such as sunshine, temperature, humidity and so on), the ambient factors of the solar power and other factors (such as sunshine angles and so on) between the historical time period and the future time period are calculated at the same time, but it is not limited to compare those three different reference data only. Then, the comparison value is compared with the error tolerance value. If the comparison values of the weather information (such as sunshine, temperature, humidity and so on), the ambient factors of the solar power and other factors (such as sunshine angles and so on) are all within the allowance range of the error tolerance values, the power output at this historical time period is acquired and the future power output is calculated accordingly. If the comparison values of the weather information (such as sunshine, temperature, humidity and so on) and the ambient factors of the solar power or other factors (such as sunshine angles and so on) are not within the allowance range of the error tolerance value, the power output at this historical time period cannot be used as reference.

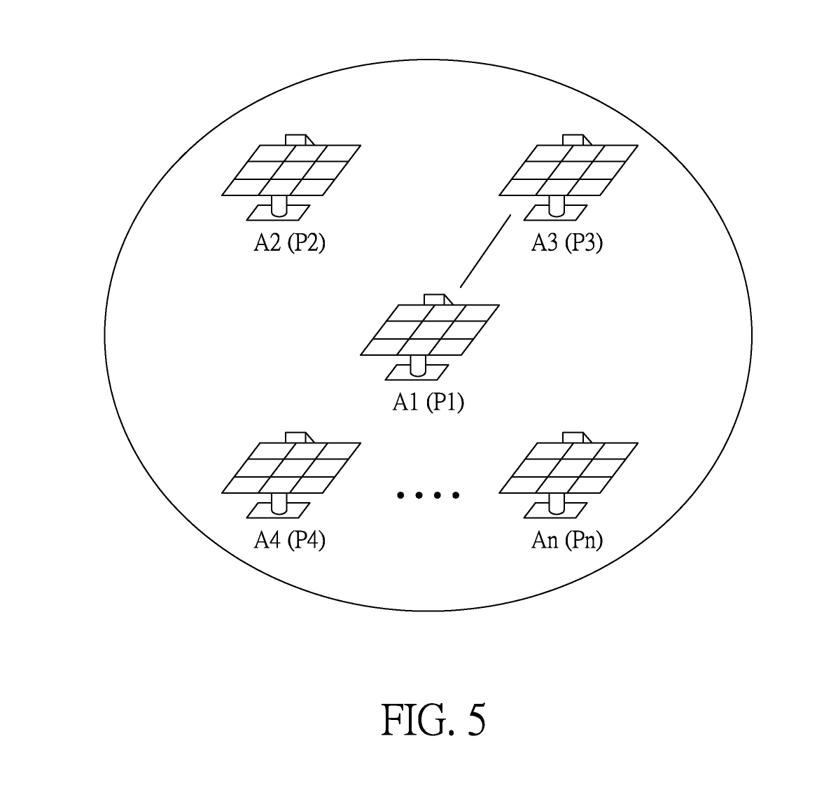

FIG. 5 is a view of the solar power plants to calculate the power output of the power plant without predictive reference data. As shown in FIG. 5, a power output of a power plant A1 is requested to be calculated and the predictable reference data of the power plant A1 is not available, but the predictable reference data of an adjacent power plant A2 is available. The aforementioned steps S101-S105 are used to calculate a predictive power output P2 of the solar power plant A2. According to a historical time period, a differential percentage value C=((P1′−P2′)/P1′) between the output power (P1′) of the solar power plant A1 and the output power (P2′) of the solar power plant A2 is calculated. Finally, the predictive power output of the solar power plant A1 is calculated in accordance with the predictive power output P2 of the solar power plant A2 and the differential percentage value.

By implementing the calculating method of the present invention, the power output of the power plant with predictable data can be calculated and the power output of the power plant without predictable data can also be calculated. According to the predictive power output, the manager can arrange power distribution effectively and the usage of the power can be more efficient to avoid an occurrence of the power shortage.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A power output calculating method of a solar power plant, comprising steps of:
acquiring at least one first reference data of a first solar power plant from at least one historical time period;
acquiring at least one second reference data of the first solar power plant;
calculating at least one comparison value between the at least one first reference data and the at least one second reference data;
acquiring at least one first historical power output of the first solar power plant corresponding to the at least one first reference data when the at least one comparison value is within an allowance range of at least one error tolerance value; and
calculating at least one first future power output of the first solar power plant in accordance with the at least one error tolerance value and the at least one historical power output.

2. The power output calculating method as claimed in claim 1 further comprising a step of:
determining that a range of the at least one first future power output of the first solar power plant is between a maximum of the at least one first future power output and a minimum of the at least one first future power output.

3. The power output calculating method as claimed in claim 1, wherein the at least one second reference data is weather forecast data from a weather forecast bureau, a weather forecast station, or a weather forecast institution.

4. The power output calculating method as claimed in claim 1, wherein the at least one second reference data is external ambient data of the first solar power plant or sunshine angle data.

5. The power output calculating method as claimed in claim 1 further comprising steps of:
acquiring a second historical power output of a second solar power plant in accordance with the at least one historical time period of the at least one first reference data of the first solar power plant;
calculating a differential percentage value between the at least one first historical power output and the second historical power output; and
calculating a second future power output of the second solar power plant in accordance with the differential percentage value and the at least one first future power output.

6. A power output calculating method of a solar power plant, comprising:
acquiring at least one first reference data of a first solar power plant from at least one historical time period;
acquiring at least one second reference data of a second solar power plant;
calculating at least one comparison value between the at least one first reference data and the at least one second reference data;
acquiring at least one first historical power output of the first solar power plant corresponding to the at least one first reference data when the at least one comparison value is within an allowance range of at least one error tolerance value; and
calculating at least one first future power output of the second solar power plant in accordance with the at least one error tolerance value and the at least one historical power output.

7. The power output calculating method as claimed in claim 6 further comprising a step of:
determining that a range of the at least one first future power output of the second solar power plant is between a maximum of the at least one first future power output and a minimum of the at least one first future power output.

8. The power output calculating method as claimed in claim 6, wherein the at least one second reference data is weather forecast data from a weather forecast bureau, a weather forecast station, or a weather forecast institution.

9. The power output calculating method as claimed in claim 6, wherein the at least one second data reference data is external ambient data of the second solar power plant or sunshine angle data.

10. The power output calculating method as claimed in claim 6 further comprising steps of:
acquiring a second historical power output of the second solar power plant and a third historical power output of a third solar power plant in accordance with the at least one historical time period of the at least one first reference data of the first solar power plant;
calculating a differential percentage value between the second historical power output and the third historical power output; and
calculating a second future power output of the third solar power plant in accordance with the differential percentage value and the at least one first future power output of the second solar power plant.
